(19) United States
(12) Patent Application Publication
(10) Pub. No.: US 2025/0276554 A1
(43) Pub. Date: Sep. 4, 2025

(54) PNEUMATIC VALVE ARRANGEMENT AND METHOD OF OPERATING A PNEUMATIC VALVE ARRANGEMENT

(71) Applicant: ZF CV Systems Europe BV, Brussels (BE)

(72) Inventor: Wojciech Iwaniec, Wroclaw (PL)

(21) Appl. No.: 19/209,537

(22) Filed: May 15, 2025

Related U.S. Application Data
(63) Continuation of application No. PCT/EP2022/083840, filed on Nov. 30, 2022.

(51) Int. Cl. B60G 17/018

(52) U.S. Cl. CPC B60G 17/0182; B60G 2202/42; B60G 2600/76

(57) ABSTRACT

A pneumatic valve arrangement is for controlling an air flow of compressed air. The valve arrangement includes a valve unit including an input port and an output port for receiving and providing compressed air and an actuator unit configured to actuate a pneumatic connection between the input port and the output port. A valve-control unit is configured to ascertain a respective actuation function associated with each of a plurality of available air flow characteristics, to ascertain, from the plurality of available air flow characteristics, a target air flow characteristic for delivering the compressed air by the pneumatic valve unit, and to control the actuator unit using the actuation function associated with the target air flow characteristic for delivering the compressed air in accordance with the target air flow characteristic.

### CROSS-REFERENCE TO RELATED APPLICATIONS

This application is a continuation application of international patent application PCT/EP2022/083840, filed Nov. 30, 2022, designating the United States, the entire content of which is incorporated herein by reference.

### TECHNICAL FIELD

The present disclosure is directed to a pneumatic valve arrangement for controlling an air flow of compressed air, to a method for controlling a pneumatic valve arrangement and to a computer program as well as to a pneumatic arrangement, to a pneumatic suspension system and to a commercial vehicle.

### BACKGROUND

US patent document U.S. Pat. No. 9,273,794 B2 describes a pneumatic valve actuator, also referred to as pneumatic valve arrangement, wherein a piston reciprocates in a cylinder in response to fluid pressure build-up in an actuating pressure chamber.

Typically, the fluid (air) flow in the pneumatic valve arrangement is fixed and determined by the minimum air-flow section of an air channel or is controlled by a variable air-flow section, which is regulating by adjusting for example a number of channels or a diaphragm. Pneumatic valve arrangements with fixed fluid flow are robust, low-cost and simple to operate. However, the fluid flow is constant and cannot be controlled. On the other hands, pneumatic valve arrangements with a variable fluid flow section enable the controlled provision of different flows values but are expensive, complex, sensitive to components deviations and typically show longer response times

It would be beneficial to reduce the technical complexity of pneumatic valve arrangements for variable fluid flow.

### SUMMARY

It is an object of the disclosure to provide a pneumatic apparatus, namely a pneumatic valve arrangement and a pneumatic arrangement including the pneumatic valve arrangement, a vehicle and a method of improved kind for controlling the pneumatic valve arrangement. The pneumatic apparatus in particular should be of reduced technical complexity but still allow for a variable fluid flow; in particular allow for different air flows at constant air supply pressure. In particular it is an object to easily mitigate tolerances of an actuator's components manufacturing and diversity of suspension systems.

According to a first aspect of the present disclosure, a pneumatic valve arrangement according to the disclosure is described.

The pneumatic valve arrangement is suitable for controlling a fluid flow, in particular an air flow of compressed air. The pneumatic valve arrangement includes a pneumatic valve unit that includes an input port for receiving the fluid, for example, the compressed air, an output port for controllably providing the fluid, for example, compressed air, and an actuator unit configured to actuate, that is, to open and close, a pneumatic connection between the input port and the output port. The pneumatic valve arrangement also includes a valve-control unit configured to control the actuator unit of the pneumatic valve unit. The valve-control unit is configured to ascertain a respective actuation function associated with each of a plurality of available air flow characteristics, to ascertain a target air flow characteristic for delivering the compressed air by the pneumatic valve unit from the plurality of available air flow characteristics, and to control the actuator unit using the actuation function associated with the target air flow characteristic for delivering the compressed air in accordance with the target air flow characteristic.

The inclusion of the valve-control unit and the operation of the valve unit in accordance with a target air flow characteristic chosen for the plurality of available air flow characteristics enables the provision of a controllable air flow via the output port of the pneumatic valve unit. Each of the air-flow characteristics is associated with a respective one of a corresponding plurality of actuation functions, based on which the actuator unit is controlled, that is, opened or closed. The intermitting actuation of the actuator unit enables a controlled provision of air flow (or in general, fluid flow) via the valve unit, without the need of complex hardware such as diaphragms of variable air channels.

The pneumatic valve arrangement of the first aspect of the disclosure enables the provision of different compressed air flows at the output port at a constant air supply pressure at the input port. Further, the pneumatic valve arrangement of the disclosure mitigates the tolerances of the valve component's manufacturing and diversity of suspension systems by enabling a fluent adaptation of the movement frequency of the actuation unit.

In the following, developments of the first aspect of the disclosure will be described.

Although some of the features of the disclosure have been defined in relation to air, or air flow, the disclosure is not restricted to the use of air or compressed air and can also be used in combination with other gases or fluids.

The flow value of compressed air at the output port is a combination of the movement frequency of the actuator unit and of the air supply pressure at the input port.

In a development, the actuation unit includes a piston and the movement of the piston is mainly determined by two parameters, namely the open/close movement of the actuation unit, which is controlled by the valve-control unit using the actuation function associated with the target air flow characteristic, and by the back pressure from the delivery line that is connected to the output port. The combination of these parameters results in a vibration or balance of the piston.

In a particular development, the valve-control unit includes a memory unit where the actuation functions associated with the plurality of available air flow characteristics are stored or are storable. Additionally, or alternatively, the target air flow characteristic is received via a dedicated input, for example in the form of an electrical signal.

In another development, the valve-control unit is configured to receive the actuation functions and/or the target air flow characteristic from an external control unit, such as for instance, an electronic control unit. In a development, the electronic control unit is advantageously configured to receive operation data indicative of the supply pressure at the input port and of the output pressure at the output port and to determine available or implementable air flow characteristics, for instance, using a neural network. The neural network can be updated using a feedback process for checking the validity of the air flow characteristics when selected as target air flow characteristics.

In another development, at least one, or preferably each one, of the actuation functions defines a repeating pulse-pattern including off-cycles with an off-cycle duration and on-cycles with an on-cycle duration.

In particular, the valve-control unit is configured to control the actuator unit to actuate the valve unit in a connection state for connecting the input port to the output port during the on-cycles and in a disconnection state for disconnecting the input port from the output port during the off-cycles.

In another development, which may include any of the technical features discussed above, the actuator unit is configured to actuate the valve unit against a spring element that is arranged and configured to exert a spring force such that, without actuation, the input port is disconnected from the output port.

In yet another development, the valve unit and the actuator unit are configured as a 2/2-way solenoid valve, or electrically controlled valve. In this development, the actuator unit receives an electrical control signal based on which the pneumatic valve unit is actuated.

In another development, the pneumatic valve unit further includes an exhaust port and the valve-control unit is further configured to control the actuator unit to actuate the pneumatic valve unit for connecting the output port and the exhaust port, in particular during the off-cycles of the actuation function associated with the target air flow characteristic. In particular, in another development the pneumatic valve unit and the actuator unit are configured as a 3/2-way solenoid valve or electrically controlled valve. In this development, the actuator unit receives an electrical control signal based on which the pneumatic valve unit is actuated.

A second aspect of the present disclosure is realized by a pneumatic arrangement, which includes a pneumatic valve arrangement in accordance with the first aspect of the disclosure and thus also shares its advantages. The pneumatic arrangement also includes a compressed air supply unit connected to the input port of the valve unit and configured to supply compressed air to the input port of the valve unit and a pneumatic unit connected to the output port of the pneumatic valve unit and configured to receive the compressed air from the output port of the valve unit for operation of the pneumatic unit.

Here again, the disclosure is not restricted to the use of air or compressed air, and it can be implemented for other types of gases or fluids suitable for pneumatic arrangements with a corresponding gas supply unit or fluid supply unit.

In a development, the pneumatic arrangement of the second aspect of the disclosure further includes an air reservoir arranged between the output port of the pneumatic valve unit and the pneumatic unit and configured to store compressed air for use in the pneumatic unit.

A third aspect of the present disclosure is formed by a pneumatic suspension system including a pneumatic arrangement in accordance with the second aspect, wherein the pneumatic unit includes a suspension-bellows configured to be operated with the compressed air.

Pneumatic suspension, also referred to as air suspension, is a type of vehicle suspension that is powered by an electric or engine-driven air pump or compressor. The compressor, acting as a compressed air supply unit, generates and pumps the compressed air into a flexible bellows, usually made from textile-reinforced rubber. Unlike hydro-pneumatic suspension, which offers many similar features, air suspension does not use pressurized liquid, but pressurized air. The air pressure inflates the bellows and raises the chassis from the axle.

Thus, according to a fourth aspect of the present disclosure, a commercial vehicle is described, which includes a pneumatic arrangement that is in accordance with the second aspect or includes a pneumatic suspension system according to the third aspect, thus sharing the advantages of the corresponding one of the second or third aspect of the disclosure.

In yet another aspect, a fifth aspect, closely related to the first aspect of the disclosure, a method for controlling a pneumatic valve arrangement is described. The method includes ascertaining a respective actuation function associated with each of a plurality of available air flow characteristics and ascertaining a target air flow characteristic for delivering the compressed air by the pneumatic valve unit from the plurality of available air flow characteristics. The method also includes controlling an actuator unit using the actuation function associated with the target air flow characteristic for delivering the compressed air in accordance with the target air flow characteristic.

The method of the fourth aspect of the disclosure thus shares the advantages of the pneumatic valve arrangement of the first aspect of the disclosure.

In a particular development of the method of the fourth aspect, each actuation function defines a repeating pulse-pattern including off-cycles with an off-cycle duration and on-cycles with an on-cycle duration. The method may include controlling an actuator unit for actuating a valve unit in a connection state for connecting an input port to an output port during the on-cycles and for actuating the valve unit in a disconnection state for disconnecting the input port from the output port during the off-cycles.

A sixth aspect of the present disclosure is realized by a computer program product including instructions which, when the program is executed by a valve-control unit of a pneumatic valve arrangement, cause the valve-control unit to carry out the steps of the method of the fifth aspect of the disclosure.

These and other aspects of the disclosure will be apparent from and elucidated with reference to the embodiments described hereinafter.

### BRIEF DESCRIPTION OF DRAWINGS

The invention will now be described with reference to the drawings wherein:

FIG. 1 is a schematic block diagram of a first embodiment of a pneumatic valve arrangement according to the disclosure;

FIG. 2 are schematic time diagrams of a plurality of different actuation functions, according to which an inventive pneumatic valve arrangement can be controlled to provide air flows with different air flow characteristics;

FIG. 3A is a schematic diagram of a second embodiment of a pneumatic valve arrangement according to the disclosure, in particular implemented as a 2/2-way electrically controlled solenoid valve;

FIG. 3B is a schematic diagram of a third embodiment of a pneumatic valve arrangement according to the disclosure, in particular implemented as a 3/2-way electrically controlled solenoid valve;

FIG. 4 is a schematic time diagram including a plurality of different actuation functions and the associated different air flow characteristics;

FIG. 5 is a schematic block diagram of an embodiment of a pneumatic arrangement configured as a pneumatic suspension system in accordance with the disclosure;

FIG. 6 is a schematic block diagram of an embodiment of a commercial vehicle in accordance with the disclosure; and,

FIG. 7 is a flow diagram of an embodiment of a method for controlling a pneumatic valve arrangement in accordance with the disclosure.

### DETAILED DESCRIPTION

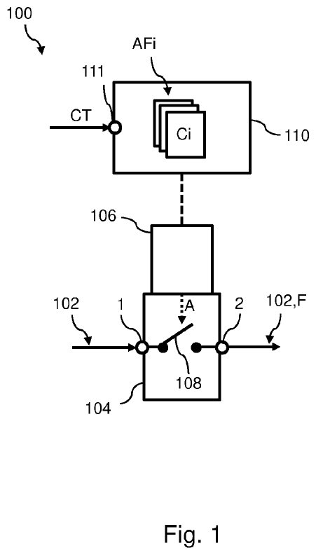

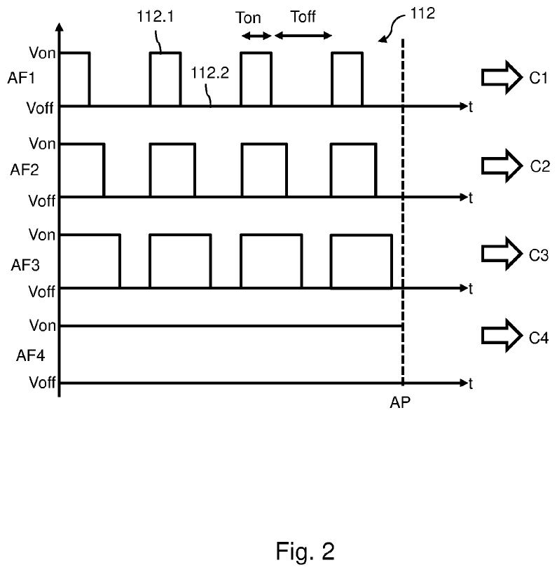

FIG. 1 shows a schematic block diagram of a first embodiment of a pneumatic valve arrangement 100 according to the disclosure. The pneumatic valve arrangement 100 of FIG. 1 is suitable for controlling a flow F of a fluid, such as compressed air. The pneumatic valve arrangement 100 includes a pneumatic valve unit 104 and a valve-control unit 110. The pneumatic valve unit 104 includes an input port 1 for receiving the compressed air 102, for instance from a compressor (not shown). It also includes an output port 2 for controllably providing the compressed air 102 and an actuator unit 106 that is configured to actuate (indicated by the reference A), that is, open and close in a controlled manner, a pneumatic connection 108 between the input port 1 and the output port 2 of the pneumatic valve unit 104. The valve-control unit 110 is configured to control the actuator unit 106 of the pneumatic valve unit 104 as indicated by the dotted line, for instance via an electrical signal, or via a pneumatic signal. Further, the valve-control unit is configured to ascertain a respective actuation function AFi, associated with each of a plurality of available air flow characteristics Ci. In this particular example, the actuations functions are prestored in the valve-control unit 110. The valve-control unit is also configured to ascertain a target air flow characteristic CT for delivering the compressed air 102 by the pneumatic valve unit 104 from the plurality of available air flow characteristics Ci. In this example, the target air flow characteristic is received via a suitable data input unit 111. The target air flow characteristic CT can be for instance provided by an external electronic control unit (ECU, not shown). The valve-control unit is further configured to control the actuator unit 106 using, or based on, that actuation function associated with the target air flow characteristic CT for delivering the compressed air 102 in accordance with the target air flow characteristic CT. This will be explained in more detail with reference to FIG. 2.

FIG. 2 shows schematic time diagrams of a plurality of different actuation functions AF1, AF2, AF3, AF4, according to which an inventive pneumatic valve arrangement, such as that of FIG. 1, can be controlled to provide air flows with different air flow characteristics C1, C2, C3, C4. In these particular examples, actuation functions AF1, AF2 and AF3 define a repeating pulse-pattern. In particular, and as an example, actuation function AF1 defines a corresponding repeating pulse pattern 112 including off-cycles 112.1 with an off-cycle duration Toff and on-cycles 112.2 with an on-cycle duration Ton. During the on-cycles 112.1 a voltage value of the actuation functions AF1, AF2, AF3 and AF4 is set at a predetermined value Von. Conversely, during the off-cycles, the voltage value of the actuation functions AF1, AF2, AF3 is set at Voff. Actuation function AF4 is constant function with a constant voltage value Von that does not vary with time and corresponds to the typical continuous operation of the valve. In another example, the actuation functions have predefined current values Ion and Ioff (not shown). Alternatively, for pneumatically controlled valves, the activation functions have predefined pressure values Pon and Poff (not shown). The operation of the pneumatic valve unit is carried out in accordance with the corresponding actuation function for the duration of an actuation period AP. The actuation period corresponds to that time period in which the pneumatic valve arrangement is operated for providing fluid. The flow of fluid, for example, compressed air, via the pneumatic valve arrangement is highest when AF4 is selected and is reduced as the Ton:Toff ratio is reduced, that is, as the time fraction of the actuation period AP in which the valve arrangement is open is reduced.

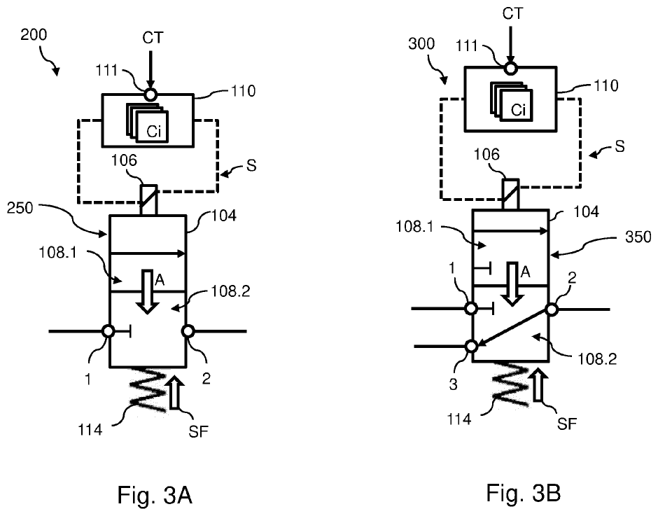

FIG. 3A shows a schematic diagram of a second embodiment of a pneumatic valve arrangement 200 according to the disclosure. For the following discussion, and for the sake of simplicity, those technical features of the pneumatic valve arrangement 200 having an identical or similar function to those of pneumatic valve arrangement 100 of FIG. 1 will be referred to using the same reference signs, and the reader is referred to the discussion of FIG. 1 above. In the pneumatic valve arrangement 200, the valve unit 104 and the actuator unit 106 are configured as a 2/2-way solenoid valve 250 that is controlled by control signals S that are provided by the valve-control unit 110 and received at the actuator unit 106, and which, for example, may correspond to any of the actuation functions AF1, AF2, AF3 or AF4, whereon Von is a voltage value that is suitable for actuating the actuator unit 106. In particular, the valve-control unit 110 is configured to control the actuator unit 106 to actuate (indicated by the reference A) the valve unit 104 in a connection state 108.1 for connecting the input port 1 to the output port 2 during the on-cycles 112.1 and in a disconnection state 108.2 for disconnecting the input port 1 from the output port 2 during the off-cycles 112.2. The actuator unit 106 is configured to actuate the valve unit 104 against a spring element 114 that is arranged and configured to exert a spring force SF such that, without actuation A, that is, in a non-actuated or relaxed state, the input port 1 is disconnected from the output port 2. The valve-control unit ascertains, for example, receives a target air flow characteristic CT indicative of one of the available air flow characteristics Ci (for example, C1, C2, C3 or C4) and then provides to the actuator unit 106, as the control signal S, a voltage signal in accordance with the actuation function associated with that available air flow characteristic Ci indicated by the target air flow characteristic CT.

FIG. 3B shows a schematic diagram of a third embodiment of a pneumatic valve arrangement 300 according to the disclosure. The difference between the pneumatic valve arrangement 300 of FIG. 3B and the pneumatic valve arrangement 200 of FIG. 3A is that the pneumatic valve arrangement of 300 is implemented as a 3/2-way electrically controlled solenoid valve 350. In particular, the valve unit 104 further includes an exhaust port 3 and the valve-control unit 110 is further configured to control the actuator unit 106 to actuate, as indicated by the reference A, the valve unit 104 for connecting the output port 2 and the exhaust port 2, in particular during the off-cycles 112.2.

The pneumatic valve arrangement can also be generally implemented as X/2-way solenoid valve (not shown), where X can exemplarily be 4, 5, or 6 in addition to 2 and 3, as explained with reference to FIG. 3A and FIG. 3B respectively.

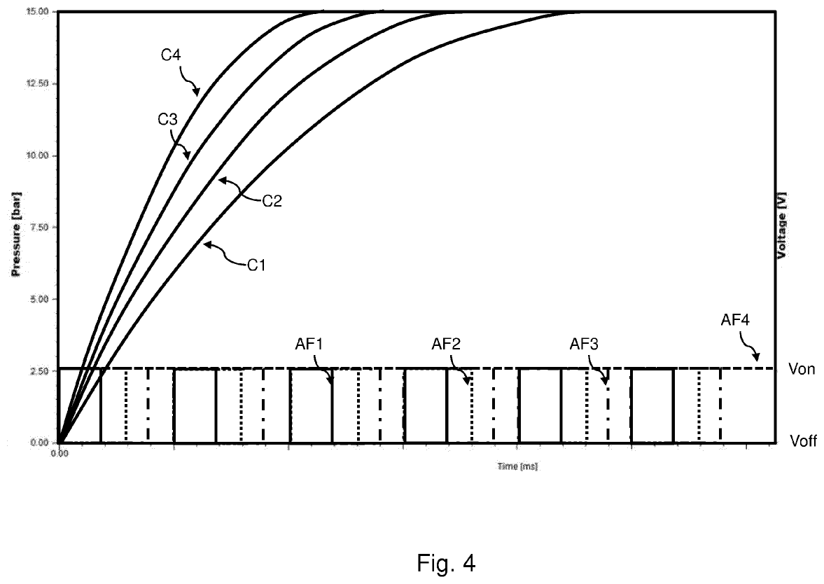

FIG. 4 shows a schematic time diagram including a plurality of different actuation functions AF1, AF2, AF3 and AF4 and the associated different air flow characteristics C1, C2, C3, C4. The actuation functions show a respective voltage-time relationship, with increasing on-cycle durations from AF1 up to AF4, for which the off-cycle duration is zero. Thus, AF4 indicates operation, and therefore provision of airflow with a constantly open valve unit 104, whereas AF1 to AF3 indicate a modulated operation, where the valve unit 104 is open/closed. The associated air flow characteristics are also shown in FIG. 4. This principle of operation enables variable airflow creating pressure steps by opening and closing of a discrete pneumatic actuator, such as a pneumatic valve unit, to fully control the characteristic curve of pressurizing and exhausting a pneumatic unit, such as an air bellows. Also shown in the diagram of FIG. 4 is the pressure at a given air bellows of a suspension system obtained by operating the pneumatic valve arrangement according to the actuation functions AF1, AF2, AF3 and AF4.

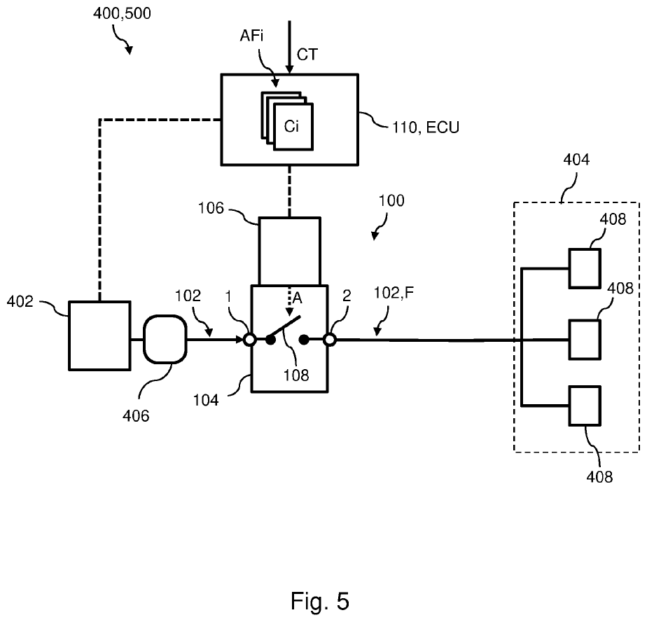

FIG. 5 shows a schematic block diagram of an embodiment of a pneumatic arrangement 400, in particular configured as a pneumatic suspension system 500, both in accordance with the disclosure. Those technical features shown in FIG. 5 that have similar or identical functions to those shown in FIGS. 1 to 4 will be referred to using the same reference numbers. The pneumatic arrangement 400 includes a pneumatic valve arrangement 100 as explained with reference to FIG. 1. It further includes a compressed air supply unit 402, such as a compressor, that is connected to the input port 1 of the valve unit 104 and configured to supply compressed air 102 to the input port 1 of the valve unit 104. The pneumatic arrangement 400 includes a pneumatic unit 404 connected to the output port 2 of the pneumatic valve unit 104 and configured to receive the compressed air 102 from the output port 2 of the pneumatic valve unit 104 for operation of the pneumatic unit 404. In this particular pneumatic arrangement, the valve-control unit 110 is integrated into an electronic control unit ECU, which has access to the plurality of available air flow characteristics and ascertains, for instance receives or determines, the target air flow characteristic CT. The determination may be performed based on sensor data or user input provided to the ECU. The ECU may also be advantageously configured to control operation of the compressed air supply unit 402, as indicated by the dotted line in FIG. 5.

The pneumatic arrangement 400 optionally further includes a fluid reservoir, such as an air reservoir 406 arranged between the compressed air supply unit 402 and the input port 1 of the pneumatic valve unit 104 and the pneumatic unit 404 and configured to store compressed air 102.

As stated above, the pneumatic arrangement is configured as a pneumatic suspension system 500, wherein the pneumatic unit 404 includes one or more suspension-bellows 408 configured to be operated with the compressed air 102. The filling of the suspension bellows can be controlled by the pneumatic valve arrangement 100 in dependence on a target air flow characteristic CT, as explained above. In another embodiment, not shown, the provision of compressed air to the bellows 408 is controlled by a respective pneumatic valve arrangement, such as pneumatic valve arrangements 100, 200 or 300.

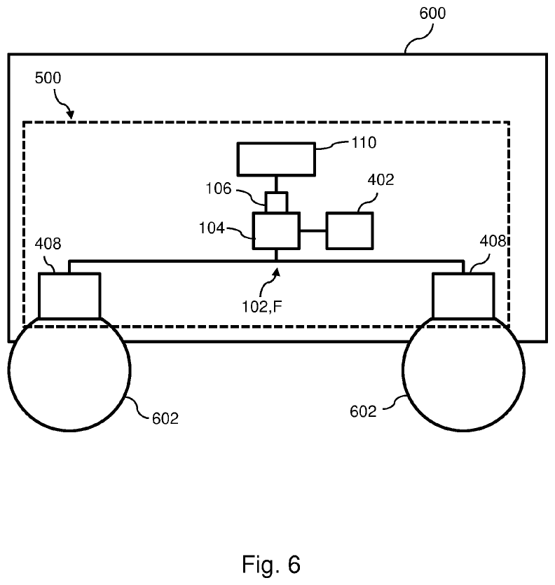

FIG. 6 shows a schematic block diagram of an embodiment of a commercial vehicle 600 in accordance with the disclosure, which includes a pneumatic suspension system 500 as described with reference to FIG. 5. The vehicle includes suspension bellows 408 that are for instance associated with a front and a rear axle, to which the wheels 602 of the commercial vehicle 600 are connected. Additionally, or alternatively, an air-bellows for cabin suspension can be provided with compressed air in a controllable manner using a pneumatic valve arrangement such as the ones (for example, 100, 200, 300) described with reference to FIG. 1, FIG. 3A and FIG. 3B.

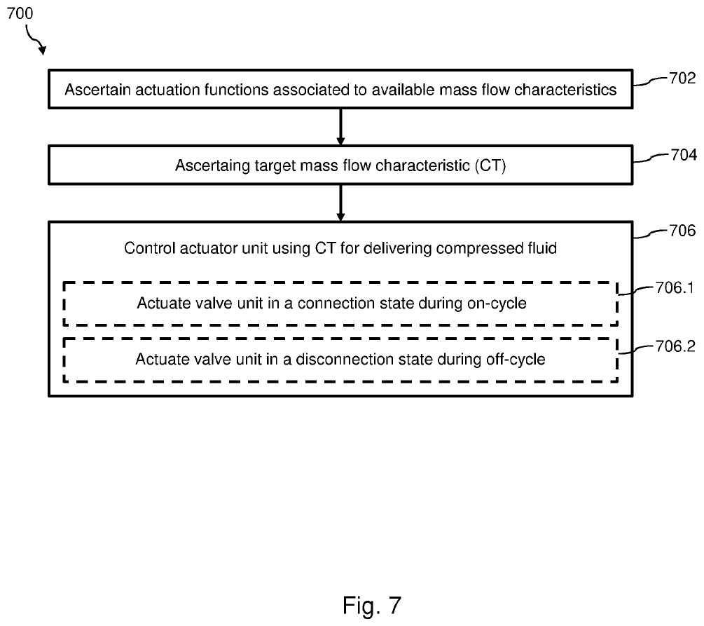

FIG. 7 shows a flow diagram of an embodiment of a method 700 for controlling a pneumatic valve arrangement 100, 200, 300 in accordance with the disclosure. The method includes, in a step 702, ascertaining a respective actuation function AFi, AF1, AF2, AF3, AF4 associated with each of a plurality of available air flow characteristics C1, C2, C3, C4. The method also includes, in a step 704, ascertaining, from the plurality of available air flow characteristics C1, C2, C3, C4, a target air flow characteristic, for delivering the compressed air 102 by a pneumatic valve unit 104. The method also includes, in a step 706, controlling an actuator unit using the actuation function AF1, AF2, AF3, AF4 associated with the target air flow characteristic CT for delivering the compressed air 102 in accordance with the target air flow characteristic CT.

Preferably, at least one, but preferably each, of the actuation function AF1, AF2, AF3, AF4 defines a repeating pulse-pattern 112 including off-cycles 112.1 with an off-cycle duration Toff and on-cycles 112.2 with an on-cycle duration Ton.

The step 706 of controlling the actuation unit 106 may include actuating 706.1 the valve unit 104 in a connection state 108.1 for connecting an input port 1 to an output port 2 during the on-cycles 112.1 and for actuating 706.2 the valve unit 104 in a disconnection state 108.2 for disconnecting the input port 1 from the output port 2 during the off-cycles 112.2.

In summary, the disclosure discloses a pneumatic valve arrangement, or valve arrangement for short, for controlling an air flow of compressed air. The valve arrangement includes a valve unit including an input port and an output port for receiving and providing compressed air and an actuator unit configured to actuate a pneumatic connection between the input port and the output port. A valve-control unit is configured to ascertain a respective actuation function associated with each of a plurality of available air flow characteristics, to ascertain, from the plurality of available air flow characteristics, a target air flow characteristic for delivering the compressed air by the pneumatic valve unit, and to control the actuator unit using the actuation function associated with the target air flow characteristic for delivering the compressed air in accordance with the target air flow characteristic.

It is understood that the foregoing description is that of the preferred embodiments of the invention and that various changes and modifications may be made thereto without departing from the spirit and scope of the invention as defined in the appended claims.

### LIST OF REFERENCE SIGNS (PART OF THE DESCRIPTION)

1 Input port
2 Output port
3 Exhaust port
100 Pneumatic valve arrangement
102 Fluid; Compressed air
104 Pneumatic valve unit; Valve unit
106 Actuator unit
108 Pneumatic connection
108.1 Connection state
108.2 Disconnection state
110 Valve-control unit
111 Data input
112 Repeating pulse pattern
112.1 Off-cycle of pulse pattern
112.2 On-cycle of pulse pattern
114 Spring element
200 Pneumatic valve arrangement
250 2/2-way solenoid valve
300 Pneumatic valve arrangement
350 3/2-way solenoid valve
400 Pneumatic arrangement
402 Fluid supply unit; Compressed air supply unit
404 Pneumatic unit
406 Fluid reservoir; Compressed air reservoir
408 Air bellows; Suspension bellows
500 Pneumatic suspension system
600 Commercial vehicle
602 Wheels
700 Method
702-706 Method steps
A Actuation of pneumatic valve unit
AFi Generic actuation function
AF1-4 Examples of actuation functions
AP Actuation period
Ci Generic available air flow characteristic
C1-4 Examples of available air flow characteristic
CT Target air flow characteristic
ECU Electronic control unit
F Fluid flow; Air flow
S Control Signal
SF Spring force
Von Voltage value during on-cycle
Voff Voltage value during off-cycle

1. A pneumatic valve arrangement for controlling an air flow of compressed air, the pneumatic valve arrangement comprising:
a pneumatic valve unit including an input port for receiving the compressed air and an output port for controllably providing the compressed air;
said pneumatic valve unit further including an actuator unit configured to actuate a pneumatic connection between said input port and said output port;
said pneumatic valve unit further including a valve-control unit configured to control said actuator unit of said pneumatic valve unit;
said valve-control unit being configured to:
ascertain a respective actuation function associated with each of a plurality of available air flow characteristics;
ascertain, from the plurality of available air flow characteristics, a target air flow characteristic for delivering the compressed air by said pneumatic valve unit; and,
control said actuator unit using the actuation function associated with the target air flow characteristic for delivering the compressed air in accordance with the target air flow characteristic.

2. The pneumatic valve arrangement of claim 1, wherein at least one of the actuation functions defines a repeating pulse-pattern including off-cycles with an off-cycle duration and on-cycles with an on-cycle duration.

3. The pneumatic valve arrangement of claim 2, wherein said valve-control unit is configured to control said actuator unit to actuate said pneumatic valve unit in a connection state for connecting said input port to said output port during the on-cycles and in a disconnection state for disconnecting said input port from said output port during the off-cycles.

4. The pneumatic valve arrangement of claim 1, wherein said actuator unit is configured to actuate said pneumatic valve unit against a spring element that is arranged and configured to exert a spring force such that, without actuation, said input port is disconnected from said output port.

5. The pneumatic valve arrangement of claim 1, wherein said pneumatic valve unit and said actuator unit are configured as a 2/2-way solenoid valve.

6. The pneumatic valve arrangement of claim 1, wherein said pneumatic valve unit further includes an exhaust port; and, wherein the valve-control unit is further configured to control said actuator unit to actuate said pneumatic valve unit for connecting said output port and said exhaust port.

7. The pneumatic valve arrangement of claim 1, wherein said pneumatic valve unit further includes an exhaust port; and, wherein the valve-control unit is further configured to control said actuator unit to actuate said pneumatic valve unit for connecting said output port and said exhaust port during the off-cycles.

8. The pneumatic valve arrangement of claim 6, wherein said pneumatic valve unit and said actuator unit are configured as a 3/2-way solenoid valve.

9. A pneumatic arrangement comprising:
a pneumatic valve arrangement having a pneumatic valve unit including an input port for receiving compressed air and an output port for controllably providing the compressed air;
said pneumatic valve unit further including an actuator unit configured to actuate a pneumatic connection between said input port and said output port;
said pneumatic valve unit further including a valve-control unit configured to control said actuator unit of said pneumatic valve unit;
said valve-control unit being configured to:
ascertain a respective actuation function associated with each of a plurality of available air flow characteristics;
ascertain, from the plurality of available air flow characteristics, a target air flow characteristic for delivering the compressed air by said pneumatic valve unit; and,
control said actuator unit using the actuation function associated with the target air flow characteristic for delivering the compressed air in accordance with the target air flow characteristic;
a compressed air supply unit connected to said input port of said pneumatic valve unit and configured to supply compressed air to said input port of said pneumatic valve unit; and,
a pneumatic unit connected to said output port of said pneumatic valve unit and configured to receive the compressed air from said output port of said pneumatic valve unit for operation of said pneumatic unit.

10. The pneumatic arrangement of claim 9 further comprising an air reservoir arranged between said compressed air supply unit and said input port and configured to store the compressed air or arranged between said output port of said pneumatic valve unit and said pneumatic unit.

11. A pneumatic suspension system comprising the pneumatic arrangement of claim 9, wherein said pneumatic unit includes a suspension-bellows configured to be operated with the compressed air.

12. A commercial vehicle comprising the pneumatic suspension system of claim 11.

13. A method for controlling a pneumatic valve arrangement, the method comprising:
ascertaining a respective actuation function associated with each of a plurality of available air flow characteristics;
ascertaining, from the plurality of available air flow characteristics, a target air flow characteristic for delivering compressed air by a pneumatic valve unit; and,
controlling an actuator unit using the actuation function associated with the target air flow characteristic for delivering the compressed air in accordance with the target air flow characteristic.

14. The method of claim 13, wherein at least one of the actuation functions defines a repeating pulse-pattern including off-cycles with an off-cycle duration and on-cycles with an on-cycle duration.

15. The method of claim 14 further comprising:
controlling the actuator unit for actuating a pneumatic valve unit in a connection state for connecting an input port to an output port during the on-cycles and for actuating the pneumatic valve unit in a disconnection state for disconnecting the input port from the output port during the off-cycles.

16. A computer program product comprising instructions which, when the program is executed by a valve-control unit, cause the valve-control unit to carry out the method of claim 13.
